(19) United States
(12) Patent Application Publication
(10) Pub. No.: US 2014/0129559 A1
(43) Pub. Date: May 8, 2014

(54) Timeline-Based Data Visualization of Social Media Topic

(71) Applicant: INTERNATIONAL BUSINESS MACHINES CORPORATION, Armonk, NY (US)

(72) Inventor: Philip F. Estes, Palmyra, VA (US)

(73) Assignee: International Business Machines Corporation, Armonk, NY (US)

(21) Appl. No.: 13/775,405

(22) Filed: Feb. 25, 2013

Related U.S. Application Data
(63) Continuation of application No. 13/671,134, filed on Nov. 7, 2012.

(51) Int. Cl. G06F 17/30

(52) U.S. Cl. CPC G06F 17/30424
USPC 707/737

(57) ABSTRACT

A mechanism is provided in a data processing system for timeline-based social media data visualization. The mechanism receives social media data from at least one social media server. The mechanism filters the social media data to identify a plurality of social media posts related to a time-based event. The mechanism assigns the plurality of social media posts into a plurality of time periods within a timeline of the time-based event. The mechanism generates a timeline-based data visualization presenting the plurality of social media posts in relation to the timeline of the time-based event and presents the timeline-based data visualization.

The present application relates generally to an improved data processing apparatus and method and more specifically to mechanisms for timeline-based data visualization of social media topic.

Social media can be defined as interactive platforms via which individuals and communities create and share user-generated content. Social media may also be defined as a group of Internet-based applications that build on the ideological and technological foundations of Web 2.0 and that allow the creation and exchange of user-generated content. When the technologies are in place, social media is ubiquitously accessible, and enabled by scalable communication techniques. Social media technologies take on different forms including magazines. Internet forums, weblogs, social blogs, microblogging, wikis, social networks, podcasts, photographs or pictures, video, rating and social bookmarking.

The advent of social media has brought about a new source of highly real-time information to a global audience. Whether a natural disaster, a high-profile court case, or a highly-anticipated space vehicle launch, many people see social media as a legitimate source for up-to-the-minute and highly localized information on such events. One common methodology to follow specific events is to use crowd-defined “hashtags.” Hashtags are words or phrases prefixed with the symbol “#,” a form of metadata tag. Also, short messages on microblogging social networking services may be tagged by including hashtags. Hashtags first appeared and were used within Internet relay chat (IRC) networks to label groups and topics. They are also used to mark individual messages as relevant to a particular group, and to mark individual messages as belonging to a particular topic or “channel.”

Social media clients with search or “stream following” capabilities, as well as social media servers or application programming interface (API) tools, allow users to follow specific events or topics. While hashtags are not centrally controlled by nature of necessity, a bell curve phenomenon applies, and useful social media postings about an event may quickly migrate to a commonly understood hashtag that may then promote to a regionally or internationally trending topic that then surfaces in other user interface (UI) elements of clients or Web sites interacting with the social media server.

### SUMMARY

In one illustrative embodiment, a method, in a data processing system, is provided for timeline-based social media data visualization. The method comprises receiving social media data from at least one social media server. The method further comprises filtering the social media data to identify a plurality of social media posts related to a time-based event. The method further comprises assigning the plurality of social media posts into a plurality of time periods within a timeline of the time-based event. The method further comprises generating a timeline-based data visualization presenting the plurality of social media posts in relation to the timeline of the time-based event. The method further comprises presenting the timeline-based data visualization.

In other illustrative embodiments, a computer program product comprising a computer useable or readable medium having a computer readable program is provided. The computer readable program, when executed on a computing device, causes the computing device to perform various ones of, and combinations of the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a Hock diagram illustrating a mechanism for timeline-based data visualization in accordance with an illustrative embodiment;

FIG. 4 depicts an example timeline-based social media data visualization in accordance with an illustrative embodiment; and

FIG. 5 is a flowchart illustrating operation of a mechanism for timeline-based data visualization in accordance with an illustrative embodiment.

### DETAILED DESCRIPTION

The illustrative embodiments provide a mechanism for timeline-based data visualization of social media topics. The mechanism comprises an interface to allow an end-user to define a search query and potentially common advanced search techniques to generate a body of data to be visualized. The mechanism comprises a filtering engine that filters data into key content, content authors, and a rough timeline of key events as “buckets” of time-sequenced data. The mechanism comprises a visualization user interface that shows the timeline of events, allows the user some means of final tweaking of analysis, and allows interaction of display with the actual events along the timeline. The visualization user interface aligns social media content to an actual event timeline. The visualization user interface may allow a user to expand key content to show repostings, key contributors, extra media, etc.

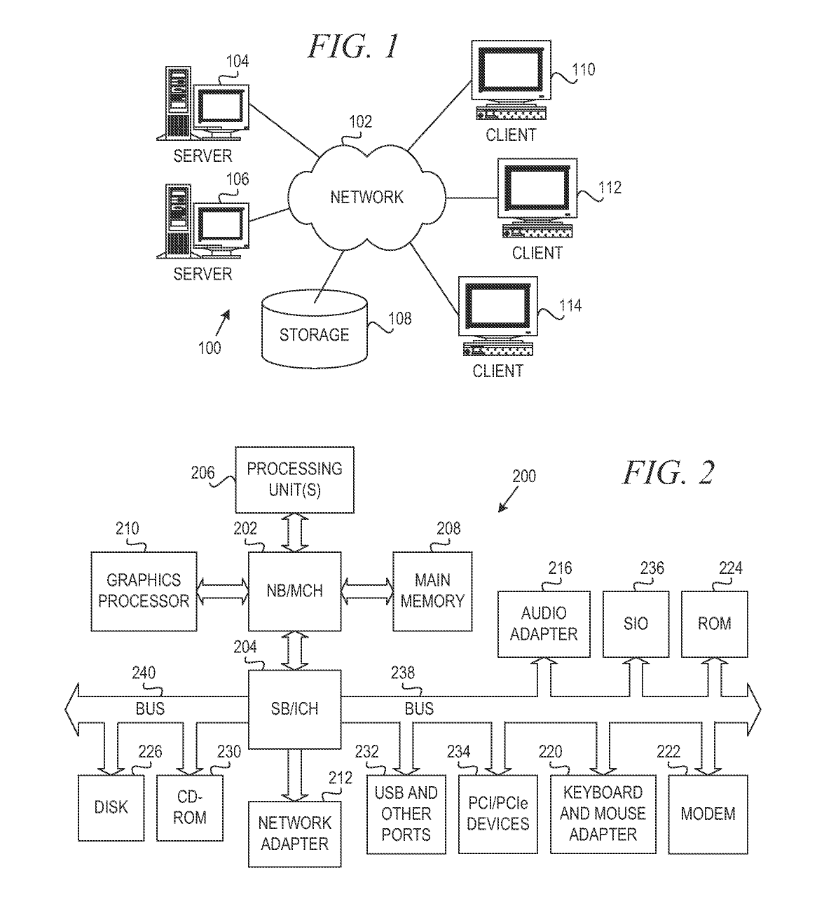

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. 119, addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modern 222, read only memory (ROM) 224, hard disk drive (HDD) 226, CD-ROM drive 230, universal serial bus (USB) ports and other communication ports 232, and PCI/PCIe devices 234 connect to SR/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Oracle and/or its affiliates.).

As a server, data processing system 200 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

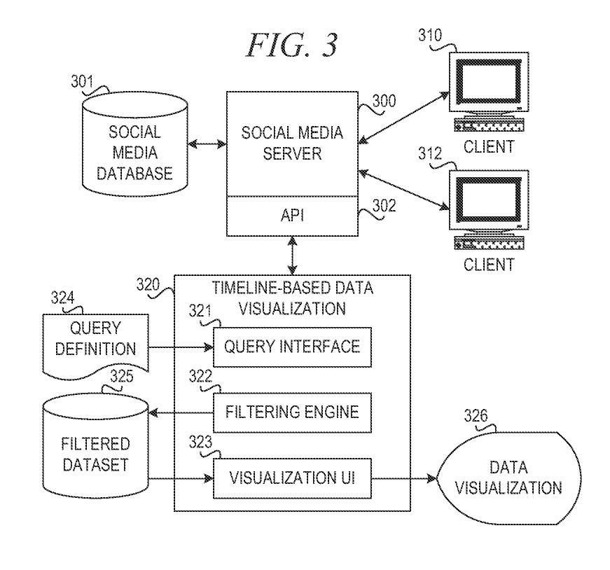

FIG. 3 is a block diagram illustrating a mechanism for timeline-based data visualization in accordance with an illustrative embodiment. One of the detrimental effects of social media is the overwhelming amount of user-generated content that may be associated with a particular hashtag or topic, especially events that have immediacy. For example, according to one social media service, during an earthquake that happened on the East coast of the United States of America, users generated 5,500 social media posts per second and 40,000 social media posts within one minute of the event.

For certain events, trying to funnel this firestorm of information into any form of data visualization may be unnecessary or even uninteresting. However, for events with both longevity and a sequence of events that is useful to be understood in a cognitive/cohesive way, even after the fact, a data visualization tool that can find the valuable information among the piles of data and align it with a series of sequence of events into a visual timeline of social media would be extremely helpful. Thus, the illustrative embodiments embody the ideas and concepts required to envision and potentially implement such a tool for social media datasets.

Social media server 300 receives social media content from users of clients 310, 312. Social media server 300 stores user-generated social media content in social media database 301. Social media content may comprise posts to a microblogging service, posts to a social networking site, images posted to a photo sharing service, or the like. Clients 310, 312 may be combinations of personal computers, tablet computers, smartphone devices, and the like. Social media server 300 also distributes social media content to clients 310, 312, which subscribe to or search for particular social media content. Social media server 300 may be server 104 in FIG. 1, for example. Clients 310, 312 may communicate with server 300 via a network, such as network 102 in FIG. 1, for example.

As an example, a user of client 310 may be a celebrity, news organization, sports team or league, or governmental organization that posts social media content for particular events. A user of client 312 may be a user that subscribes to a media stream or may search for a particular topic or hashtag. Social media server 300 may receive social media content from client 310 and distribute the content to client 312.

Timeline-based data visualization mechanism 320 communicates with social media server 300 via an application programming interface (API) 302. Timeline-based data visualization mechanism 320 may be embodied in a server, such as server 106, or in a client, such as client 114. In an alternative embodiment, timeline-based data visualization mechanism 320 may be embodied within the same data processing system as social media server 300. In one embodiment, timeline-based data visualization mechanism 320 may interface with multiple social media servers.

Timeline-based data visualization mechanism 320 comprises query interface 321, which receives a query definition 324 from a user. Query definition 324 establishes an event-based topic to search for relevant social media content from social media database 301. The topic may be defined using hashtag, for example, or a keyword if API 302 supports keyword searching. Query definition 324 may also set forth bounding data, such as start and end dates/times to limit potential clutter or unintentional results from outside the known event window. The social media server API 302 may then gather the data set of raw results based on the user's specified search criteria.

An example of an event may be an American football game. The bounding data for an American football game may comprise a start time and an end time, but may also include start and end times of each quarter. In another embodiment, the bounding data may establish bounding data for each team's possession of the ball. Another example of an event may be a debate. The bounding data for a debate may comprise a start time and end time, but my also include start and end times of each topic of the debate. Still another example of an event may be a Mars rover landing, and the bounding data may comprise a selected start time leading up to the landing and an end time, which is a predetermined time after the actual rover landing. A person of ordinary skill in the art will recognize that query definition 324 may define any time-based event to be visualized.

Query definition 324 may also define time periods within the bounding data to establish time “buckets” into which social media posts may be assigned. For instance, for an American football game, the time periods may be each team's possessions or the minutes surrounding, big plays. For a debate, the time periods may comprise the minutes surrounding answers or statements that may have prompted a flurry of social media posts.

Timeline-based data visualization mechanism 320 also comprises filtering engine 322, which uses algorithms to refine the raw data into a reduced data set that contains the expected most useful information, aligned by timestamps into time periods of activity. Filtering engine 322 may use data mining techniques to identify the specific meaning of an event or string of details comprising an event. Filtering engine 322 may take unstructured data from social media postings and collect them into time periods to represent key segments of an event timeline.

Filtering engine 322 reduces noise in the raw data received from social media database 301 to collapse reposted content back to the original author. Filtering engine 322 uses heuristic and regular expression string concepts to filter out “me too” or spurious comment additions to reposted phrases of information. For example, “felt the earthquake in #Charlottesville!” is a primary source, but “RT @soandso: felt the earthquake in #Charlottesville!//yeah, me too!!!” is not a primary post and may be marked as a repost even though it is not a native repost in the terms of the social media server and may appear as a separate entity.

Filtering engine 322 identifies primary sources by recognizing a collection of content authors who appear to be primary in the event generation. For example, certain content authors may be recognized as primary sources may be recognized as primary sources for a given event. An official content source, such as a sports team, news organization, or government organization, may be recognized as a primary source. Filtering engine 322 may also sort by count of overall body of posts and reposts for an event. Thus, an original post that is reposted a predetermined number of times, then the original post is recognized to be a primary source post rather than the reposts.

Filtering engine 322 may also assign social media posts to time periods. Some event markers will naturally fall out as reduction of noise and collection of repost information is gathered. That is, filtering engine 322 identifies clusters of posts that align time-wise around significant events in the timeline, referred to as key event markers. As an example, a source may post, “the 53 yard FG is good, going to OT in the #championshipgame.” This post may mark a significant event around which many other posts may be clustered.

Timeline-based data visualization mechanism 320 also comprises visualization user interface (UI) 323. Filtering engine 322 creates a filtered dataset and associated metadata “database” 325, which may be used by visualization UI 323. While visualization UI 323 does not necessarily imply a Web or traditional user interface, a Web UI is a naturally envisioned embodiment as the metadata links back to the original social media database 301 will integrate nicely with a Web interface.

Visualization UI 323 may have the ability to refine, and potentially store/publish, the outcome of the dataset filter to align to an externally imposed timeline. Visualization UI 323 generates data visualization 326, which presents a timeline of an event and social media posts associated with time periods within the timeline of the event. Data visualization 326 may allow a user to expand and collapse time periods or focus on key events within the timeline. Data visualization 326 may present representative social media posts from primary sources in association with time periods or key events within the timeline.

Given an officially timestamped sequence of events, visualization UI 323 may re-flow its events by adding markers to the timeline with the official sequence and data markers will align inside or outside the various event sections. An example of a timestamped sequence of events may be defense motions, defense rests, witness takes stand, etc., in a trial. Another example of a timestamped sequence of events may be a launch timeline. Still another example of a timestamped sequence of events may be scoring plays in a sporting event. Other examples wilt be readily apparent to a person of ordinary skill in the art.

Visualization UI 323 may also have the ability to expand data points with their associated data and media. For example, visualization UI 323 may present how many times a source post was reposted and by whom or links to the original post. Visualization UI 323 may also present a picture that was posted, a link to a news source or Web site, or a video.

Visualization UI 323 may have the ability to look at summary metadata. For example, visualization 323 may present who posted the most about an event, top contributors, how many social media postings per event marker, total social media postings for an entire event, a graph of post counts over time, etc.

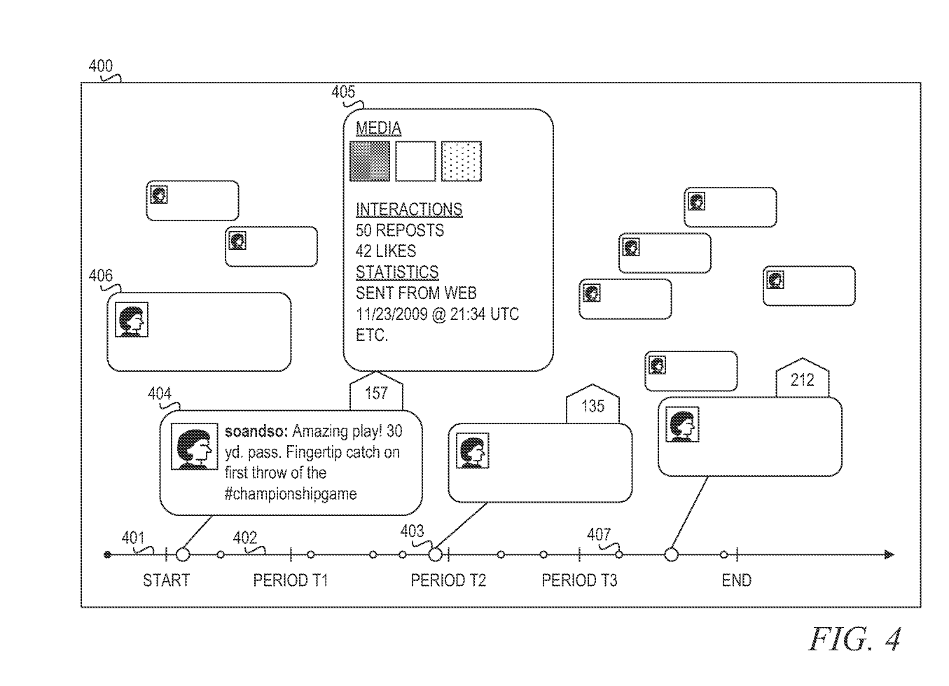

FIG. 4 depicts an example of timeline-based social media data visualization in accordance with an illustrative embodiment. Timeline-based social media data visualization 400 comprises a timeline 401 having an event start time and an event end time. Timeline 401 may have established time periods, such as the time period 402 between event start time and the time period T1 marker. In the case of an American football game, for example, start time, may be the opening kickoff and time period T1 marker may mark the end of the first quarter, making time period 402 the first quarter of the game. Timeline 401 may also present social media post clusters 403, which may occur around key events.

Data visualization 400 may present representative social media posts, such as primary source post 404. In the depicted example, primary source post 404 is associated with a key event or cluster of social media posts on timeline 401. Primary source post 404 presents the author and content of the post. Primary post 404 also presents a “score” (157 in the depicted example) for the post. Data visualization 400 may also present other clusters 407 of social media activity that do not have a high enough score to display in the upper field. Primary post 404 is considered an important posting representing a post with a high score and aligning with a significant cluster of social media activity.

Data visualization 400 also presents media, interactions, and statistics 405 associated with primary source post 404. The media may include images or video associated with the primary source post 404. In the depicted example, primary source post 404 is related to a key play in an American football game, and the media may include pictures and/or video of the play, sound of a radio call of the play, or a link to an official Web site or posting. Data visualization 400 may allow the user to select an image or video for presentation. The interactions include a number of reposts or likes of the primary source post 404. Statistics provide metadata about the primary source posting 404, including where it was posted, date and time, etc.

Data visualization 400 also presents other representative posts 406, which may be from other primary sources or may be secondary posts. Representative posts 406 may form a “cloud” around the higher scoring posts in the background. For example, representative post 406 may be post by a lesser primary source than primary source post 404. As another example, representative post 406 may be a secondary post, such as a repost of primary source post 404. Data visualization 400 may allow the user to drill down to the post 406, refocusing the display on post 406, thus providing media, interactions, and statistics about post 406. Data visualization 400 may then allow a user to drill down to a secondary post, such as a repost.

Data visualization 400 may also allow the user to drill down to a selected time period, such as time period 402, refocusing the display to only posts within the selected time period. Data visualization 400 may also allow the user to drill down to a selected cluster of posts, refocusing the display to only posts assigned to the cluster of posts or the key event. For instance, a user may select cluster 403, and data visualization 400 may refocus the display to a primary source post related to a key event around which cluster 403 is aligned. As an example, cluster 403 may be a scoring play in an American football game that inspired a cluster of posts. Data visualization 400 may select a recognized primary source post related to the scoring play and refocus the display around that post.

In one example embodiment, the timeline-based social media data visualization tool may remove hashtags that were part of the query, given that it is a component of every result entry. It may be considered overkill to present common components in results given the space constraint potential of the user interface with a large number of postings.

As will be appreciated by one skilled in the art, the present invention may be embodied as a system, method, or computer program product. Accordingly, aspects of the present invention may take the form of an entirety hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internct Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

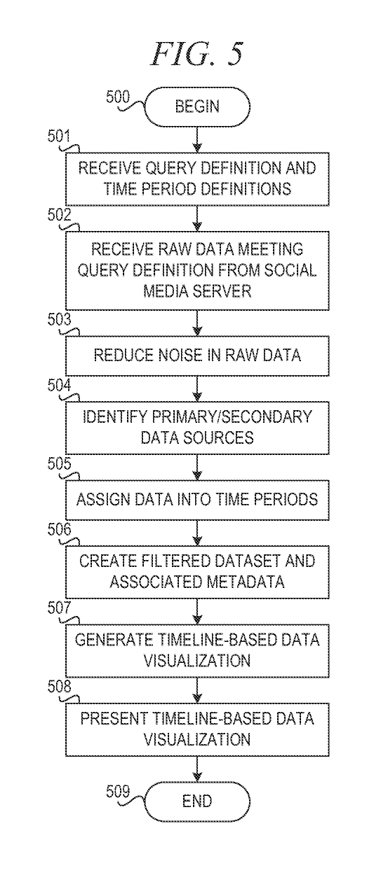

FIG. 5 is a flowchart illustrating operation of a mechanism for timeline-based data visualization in accordance with an illustrative embodiment. Operation begins (block 500), and the mechanism receives a query definition and time period definitions (block 501). The time periods may be sub-periods within an overall event timeline or key events that may likely inspire a cluster of social media posts. The mechanism searches the social media server via an application programming interface (API) and receives raw data meeting the query definition from the social media sever in response to the query (block 502).

The mechanism reduces noise in the raw data (block 503). The mechanism identifies primary and secondary data sources (block 504). The mechanism assigns data into time periods (block 505). The mechanism then creates a filtered dataset and associated metadata (block 506). The mechanism generates a timeline-based social media data visualization (block 507) and presents the timeline-based social media data visualization (block 508). The mechanism may present the data visualization as an interactive display, allowing the user to drill down to time periods, key events, secondary source posts, and so forth. Thereafter, operation ends (block 509).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for timeline-based social media data visualization. The mechanisms query social media servers for social media data relating to an event. The mechanisms performing data mining and filtering techniques to identify primary sources of social media posts and to assign data into time periods with respect to an event timeline. The mechanisms generate timeline-based data visualizations of social media data. The timeline-based data visualizations allow users to interact with the segments/points on the timeline to reveal social media sources.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for timeline-based social media data visualization, the method comprising:
receiving social media data from at least one social media server;
filtering the social media data to identify a plurality of social media posts elated to a time-based event;
assigning the plurality of social media posts into a plurality of time periods within a timeline of the time-based event;
generating a timeline-based data visualization presenting the plurality of social media posts in relation to the timeline of the time-based event; and
presenting the timeline-based data visualization.

2. The method of claim I, wherein receiving social media data from at least one social media server comprises:
receiving a query definition comprising an event start time and an event end time;
searching the at least one social media server based on the query definition; and
receiving the social media data from the at least one social media server, wherein the social media data satisfies the query definition.

3. The method of claim 2, wherein the query definition comprises a search term for the time-based event, wherein searching the at least one social media server based on the query definition comprise searching the at least one social media server for social media posts containing the search term.

4. The method of claim 3, wherein the search term comprises a hashtag.

5. The method of claim 1, wherein filtering the social media data comprises reducing noise in the social media data.

6. The method of claim 1, wherein filtering the social media data comprises identifying primary sources of social media posts in the social media data.

7. The method of claim 1, wherein assigning the plurality of social media posts into time periods within the timeline of the time-based event comprises assigning the plurality of social media posts into one or more predefined time periods.

8. The method of claim 1, wherein assigning the plurality of social media posts into time periods within a timeline of the time-based event comprises identifying clusters of social media posts corresponding to key events within the time-based event.

9. The method of claim 1, wherein the timeline-based data visualization presents the timeline of the time-based event, wherein the timeline comprises an event start time and an event end time.

10. The method of claim 9, wherein the timeline-based data visualization presents the plurality of time periods on the time.

11. The method of claim 9, wherein the timeline-based data visualization presents at least one social media post from an identified primary social media source in relation to a key event on the timeline.

12. The method of claim 11, wherein the timeline-based data visualization presents media associated with the key event.

13. The method of claim 11, wherein the timeline-based data visualization presents interactions and statistics associated with the at least one social media post.

14. The method of claim 11, wherein the timeline-based data visualization presents at least one report of the at least one social media post.

15-24. (canceled)
